(19) United States
(12) Patent Application Publication
(10) Pub. No.: US 2026/0058515 A1
(43) Pub. Date: Feb. 26, 2026

(54) MOTOR FRAME AND MOTOR DEVICE

(71) Applicant: Panasonic Intellectual Property Management Co., Ltd., Osaka (JP)

(72) Inventors: TOMOYA SHIMOKAWA, Osaka (JP); YASUAKI MATSUSHITA, Kyoto (JP); NORITAKA ASO, Kyoto (JP); KENTA SUZUKI, Osaka (JP)

(21) Appl. No.: 19/105,146

(22) PCT Filed: Jul. 25, 2023
(86) PCT No.: PCT/JP2023/027217

§ 371 Date: Feb. 20, 2025

(30) Foreign Application Priority Data
Aug. 31, 2022 (JP) 2022-138760

(51) Int. Cl. H02K 5/04; H02K 11/00

(52) U.S. Cl. CPC H02K 5/04; H02K 11/0094

(57) ABSTRACT

Tubular body of motor frame allows stator of motor to be fitted and includes a hole penetrating tubular body in the extension direction of axis of rotating shaft. Stator includes a plurality of stator segments obtained by dividing stator in the circumferentially around shaft. The thickness of tubular body in the internal-external direction perpendicular to the extension direction of axis is defined as a wall thickness t. An angle θ with respect to a reference line around axis is defined at any point of tubular body when tubular body is viewed in the extension direction. A thickness function t=f(θ) is defined. A portion of inner wall surface at an angle where the minimum value of the waveform of a quartic component in the Fourier series expansion of the thickness function is obtained is a center contact that contacts center portions of stator segments circumferentially.

### TECHNICAL FIELD

The present disclosure relates to a motor frame and a motor device. More specifically, the present disclosure relates to a motor frame and a motor device including the motor frame the motor including a tubular body, the tubular body including four planar outer wall surfaces and a cylindrical inner wall surface.

### BACKGROUND ART

Patent Literature 1 discloses a method for manufacturing a brushless motor stator. A stator core includes a plurality of core segments each of which includes a tooth unit and is disposed so that a tip of the tooth unit is oriented toward the central axis of the motor. The method for manufacturing the stator includes: a winding step of winding wire around the tooth unit while butt portions of the tooth units adjacent to each other in the circumferential direction of the stator core are kept separated; and a fixing step of, after the winding step, causing the core segments to be unable to move against each other while the butt portions of the tooth units circumferentially adjacent to each other are in circumferential contact with each other. At the fixing step, while the butt portions of the tooth units circumferentially adjacent to each other are in circumferential contact with each other, the outer circumferential surfaces of the core segments are pressure-bonded to the inner circumferential surface of a motor case without welding the core segments together, whereby the core segments are unable to move against each other.

Thus, at the winding step, wire is wound around each of the tooth units in the state in which the butt portions of the tooth units circumferentially adjacent to each other are separated from each other, and therefore the wire can be easily wound around each of the tooth units with a high packing factor.

### CITATION LIST

Patent Literature 1: Japanese Unexamined Patent Application Publication No. 2009-183032

### SUMMARY OF THE INVENTION

The motor case described in Patent Literature 1 has an annular shape and the circumferential thickness distribution of the motor case is approximately uniform, so that the shape of the stator core to be fitted into the motor case can be more easily made close to a perfect circle.

However, there is a problem in that, when the external shape of the motor case is not annular and the circumferential thickness distribution of the motor case is greatly non-uniform, the shape of the stator core to be fitted into the motor case largely deviates from a perfectly circular shape, whereby a large effect such as the generation of cogging torque in the motor is more easily brought about.

An object of the present disclosure is to provide a motor frame and a motor device that easily make uniform the distribution of stress applied to a stator fitted thereinto.

A motor frame according to one aspect of the present disclosure includes a tubular body. The tubular body allows a motor to penetrate in the extension direction of the axis of a rotating shaft of the motor including a stator to be fitted into the tubular body. The stator of the motor includes a plurality of stator segments obtained by dividing the stator in the circumferential direction of the rotating shaft, each of the stator segments including a tooth extending toward the axis. The tubular body includes four outer wall surfaces and an inner wall surface. The four outer wall surfaces are disposed to surround the rotating shaft and are each in a planar shape along the rotating shaft. The inner wall surface surrounds the rotating shaft and has a cylindrical inner surface shape along the rotating shaft. The thickness of the tubular body in the internal-external direction perpendicular to the extension direction of the axis is defined as wall thickness t (mm). An angle with respect to a reference line around the axis at any point of the tubular body is defined as angle θ (°). Assuming that the thickness t is a function of angle θ, the thickness function is defined as t=f(θ). A portion of the inner wall surface at an angle at which the minimum value of the waveform of a quartic component resulting from the Fourier series expansion of the thickness function is obtained is a center contact portion configured to come into contact with center portions of the stator segments in the circumferential direction of the rotating shaft.

A motor device according to one aspect of the present disclosure includes the motor frame according to the aspect and the motor.

The motor frame and the motor device of the present disclosure can easily make uniform the distribution of stress applied to a stator fitted thereinto.

### BRIEF DESCRIPTION OF THE DRAWINGS

FIG. 1 is an exploded perspective view illustrating a motor device according to an embodiment of the present disclosure.

FIG. 2 is a front view illustrating the motor device according to the embodiment of the present disclosure.

FIG. 3 is a front view illustrating the motor device according to the embodiment of the present disclosure, in which a substrate of the motor device is removed.

FIG. 4 is a perspective view illustrating stator segments of the motor device according to the embodiment of the present disclosure.

FIG. 5 is a front view illustrating a core of the motor device according to the embodiment of the present disclosure.

FIG. 6 is a perspective view illustrating a motor frame of the motor device according to the embodiment of the present disclosure.

FIG. 7 is a diagram illustrating a relationship between the wall thickness t of the motor frame and the angle θ according to the embodiment of the present disclosure.

### DESCRIPTION OF EMBODIMENT

### (1) Outline

An embodiment of a motor frame and a motor device according to the present disclosure will be described in the following. The embodiment described below is merely one of various embodiments of the present disclosure, and can be variously modified depending on a design choice or any other factor as long as the object of the present disclosure is achieved.

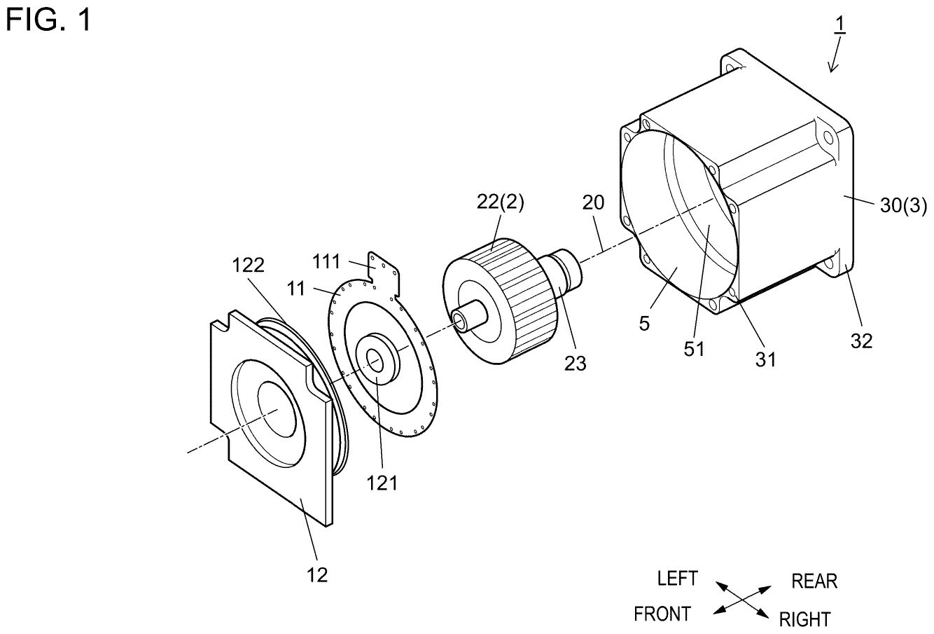

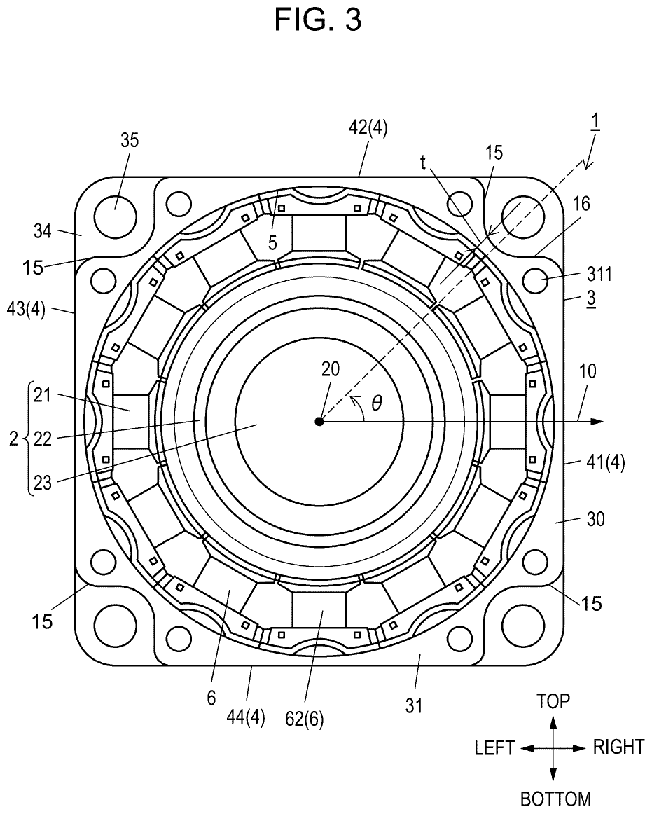

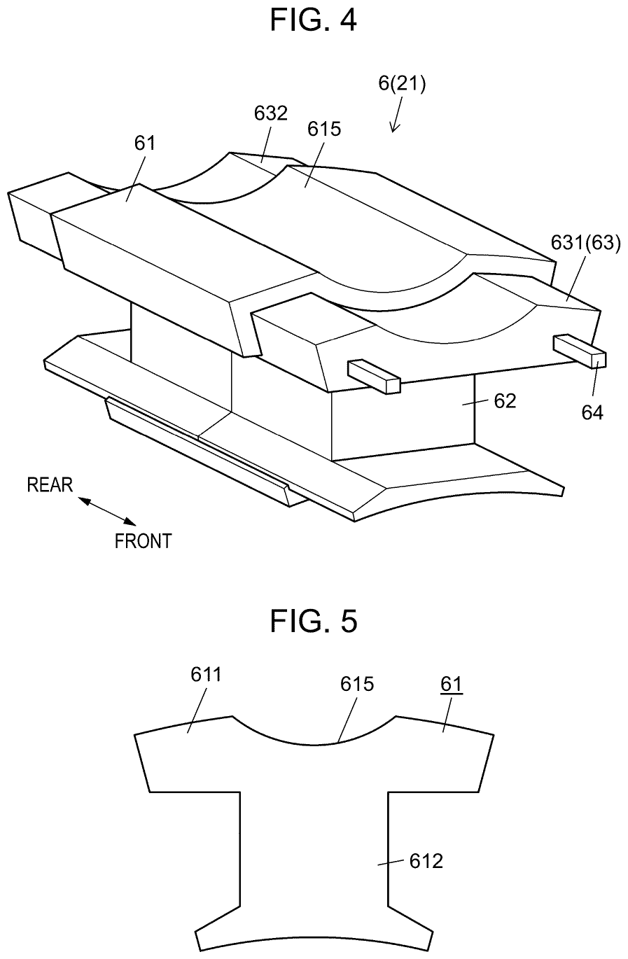

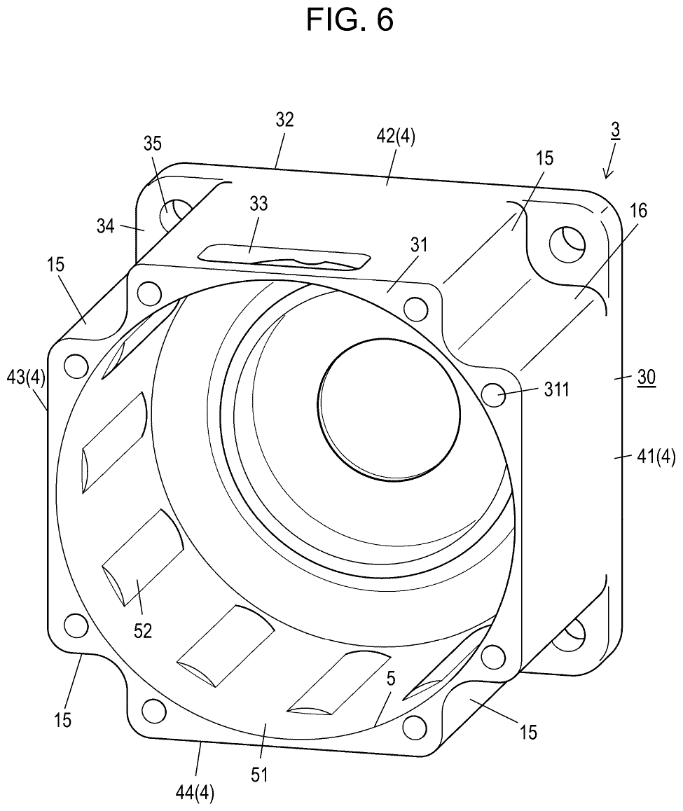

As illustrated in FIG. 1, motor frame 3 of motor device 1 according to the present disclosure includes tubular body 30. Tubular body 30 allows motor 2 to penetrate in the extension direction of axis 20 of rotating shaft 23 of motor 2, motor 2 including stator 21 (see FIG. 3) to be fitted into tubular body 30. As illustrated in FIG. 3, stator 21 of motor 2 includes a plurality of stator segments 6 (see FIG. 4) obtained by dividing stator 21 in the circumference direction of rotating shaft 23, each stator segment 6 including tooth 612 (see FIG. 5) extending towards axis 20. Tubular body 30 includes four outer wall surfaces 4 and inner wall surface 5 (for example, see FIG. 6). Four outer wall surfaces 4 are disposed to surround rotating shaft 23 and each outer wall surface 4 has a planar shape along rotating shaft 23. Inner wall surface 5 has a cylindrical inner surface shape to surround rotating shaft 23 and extends along rotating shaft 23. The thickness of tubular body 30 in the internal-external direction perpendicular to the extension direction of axis 20 is defined as wall thickness t (mm). An angle with respect to a reference line around axis 20 at any point of tubular body 30 is defined as angle θ (°). The wall thickness t is dependent on the angle θ, and therefore, the wall thickness t can be defined as a function of the angle θ. This is called a thickness function, and the thickness function is defined as t=f(θ). A portion of inner wall surface 5 positioned at an angle at which the minimum value of a quartic component resulting from the Fourier series expansion of the thickness function is obtained is a center contact portion configured to come into contact with center portions of stator segments 6 in the circumferential direction of rotating shaft 23.

As illustrated in FIG. 1, motor device 1 according to the present disclosure includes motor frame 3 and motor 2.

In motor frame 3 and motor device 1 according to the present disclosure, a portion positioned at an angle at which tubular body 30 is most greatly deformed is not in agreement with a boundary portion between two adjacent stator segments 6 at which stator 21 is most greatly deformed and thus tubular body 30 and stator 21 are substantially prevented from being greatly deformed. As a result, cogging torque generated in motor 2 can be reduced.

### (2) Details

Hereinafter, the motor frame and the motor device according to an embodiment will be described with reference to FIG. 1 to FIG. 7.

### (2.1) Outline of Motor Device

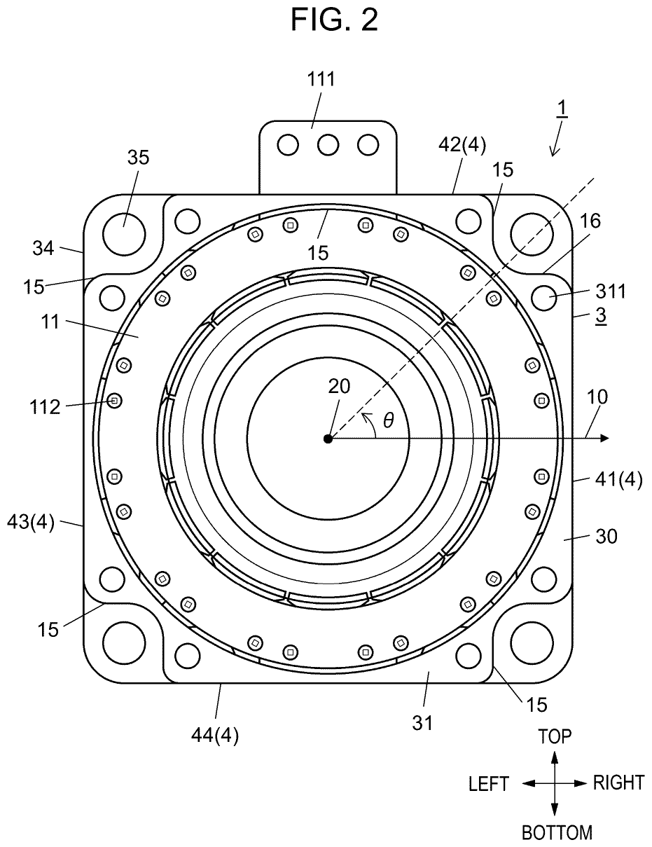

FIG. 1 is an exploded perspective view of motor device 1 according to the embodiment of the present disclosure. FIG. 2 is a front view of motor device 1 according to the embodiment of the present disclosure.

As illustrated in FIG. 1 and FIG. 2, motor device 1 includes motor (electric motor) 2 and motor frame 3 into which motor 2 is fitted. Motor 2 is what is called a servomotor. Motor device 1 further includes substrate 11, position detector 121, bracket 12, and seal 122. Substrate 11 is a printed circuit board. When substrate 11 is viewed from the extension direction of axis 20, the external shape of substrate 11 is round, and substrate 11 includes a circular opening through which later-described rotor 22 and rotating shaft 23 pass and substrate 11 has the same annular shape as that of stator 21. In substrate 11, protrusion 111 is formed to be connected to an external signal line or an external power line. In the present embodiment, protrusion 111 protruding in a direction opposite to axis 20 from a main body of annular-shaped substrate 11. In substrate 11, a plurality of positioning holes 112 is formed to penetrate substrate 11 in the extension direction of axis 20. Position detector 121 converts the amount of displacement in the rotation of motor 2 around its rotor axis into a digital amount. Bracket 12 is a member for attaching the position detector to motor frame 3. Bracket 12 is a plate-shaped member including an opening inside. Position detector 121 is attached to bracket 12 by an appropriate attachment method such as screwing. Bracket 12 to which position detector 121 is attached is attached to motor frame 3 by an appropriate attachment method such as screwing.

### (2.2) Motor

FIG. 3 is a front view of motor device 1 according to the embodiment of the present disclosure, in which substrate 11 is removed. As illustrated in FIG. 3, motor 2 includes stator 21, rotor 22, and rotating shaft 23. Here, as illustrated in FIG. 1, a front-rear direction and a left-right direction are defined for convenience. The extension direction of axis 20 of rotating shaft 23 is defined as the front-rear direction. One side of the front-rear direction is defined as a front side and the other side is defined as a rear side. The left and right when viewed from the front side toward the rear side are defined as a left side and a right side, respectively.

As illustrated in FIG. 3, stator 21 is fitted into motor frame 3 by shrink-fitting. Stator 21 generates magnetic force to rotate rotor 22. Stator 21 includes a plurality of stator segments 6. Stator segments 6 are divisions disposed in the circumferential direction of rotating shaft 23. In the present embodiment, stator 21 is uniformly divided into twelve stator segments 6 in the circumferential direction of rotating shaft 23.

FIG. 4 is a perspective view of stator segment 6 of motor device 1 according to the embodiment of the present disclosure. FIG. 5 is a front view of core 61 of motor device 1 according to the embodiment of the present disclosure. As illustrated in FIG. 4, stator segment 6 includes core 61, winding coil 62, and insulator 63. As illustrated in FIG. 5, core 61 includes base 611, tooth 612, and recess 615. Base 611 is coupled to base 611 of adjacent stator segment 6. When base 611 of all stator segments 6 constituting stator 21 are coupled to each other, an annular shape around axis 20 is formed. In the present embodiment, stator 21 is divided into twelve stator segments 6, hence one stator segment 6 occupies a 30-degree area of stator 21.

Tooth 612 extends from base 611 toward axis 20. Winding coil 62 is wound around tooth 612 via insulator 63.

Recess 615 is formed on a surface of base 611 on a side opposite to a side on which tooth 612 protrudes. In the present embodiment, recess 615 is a recessed groove having an arc-shaped cross-section, the recessed groove extending parallel to the extension direction of axis 20.

As illustrated in FIG. 4, insulator 63 includes: first insulator 631 configured to cover the front end of core 61; and second insulator 632 configured to cover the rear end of core 61.

Pin 64 is provided in first insulator 631. Pin 64 is drawn through-hole 112 formed on substrate 11.

Rotor 22 is disposed inside motor frame 3 (stator 21) so as to be rotatable with respect to stator 21. Motor 2 is an inner rotor electric motor in which rotor 22 is positioned closer to rotating shaft 23 than stator 21. Rotor 22 is surrounded by a stator core and rotates by magnetic force generated by the stator core.

Rotating shaft 23 is a shaft fixed at the center of rotor 22. Rotor 22 and rotating shaft 23 rotate about axis 20 of rotating shaft 23. Rotating shaft 23 is made of metal and extends along axis 20 on both sides of rotor 22. Rotating shaft 23 is fitted into an opening formed at the center of rotor 22 by shrink-fitting and is fixed to rotor 22.

Rotating shaft 23 is rotatably supported in stator 21 by first and second bearings. The first and second bearings are rolling bearings configured to rotatably support rotating shaft 23. The first bearing is fitted into motor frame 3 and attached to motor frame 3. The second bearing is attached to bracket 12 by an appropriate attachment method such as screwing.

### (2.3) Motor Frame

### (2.3.1) Tubular Body

FIG. 6 is a perspective view of motor frame 3 of motor device 1 according to the embodiment of the present disclosure. As illustrated in FIG. 1 and FIG. 6, motor 2 is attached to motor frame 3, so that motor frame 3 holds motor 2. Motor frame 3 includes tubular body 30. Stator 21 of motor 2 is fitted into tubular body 30. Tubular body 30 has a tubular shape and allows motor 2 to penetrate in the extension direction of axis 20 of rotating shaft 23 of motor 2.

### (2.3.2) End Surface

Tubular body 30 includes two end surfaces (first end surface 31 and second end surface 32), four outer wall surfaces 4, inner wall surface 5, and four joint portions 15.

As illustrated in FIG. 1 and FIG. 2, tubular body 30 includes first end surface 31 on the front side and second end surface 32 on the rear side. The outer edge of first end surface 31 has an approximately quadrilateral shape, more specifically a rectangular shape, still more specifically a regular square shape. The inner edge of first end surface 31 has a circular shape. The normal of first end surface 31 is oriented forward.

The outer edge of second end surface 32 has an approximately quadrilateral shape, more specifically a rectangular shape, still more specifically a regular square shape. The inner edge of second end surface 21 has a circular shape. The normal of second end surface 32 is oriented rearward.

The outer edge of first end surface 31 and the outer edge of second end surface 32 are approximately the same in size when viewed in the extension direction of axis 20. Tubular body 30 has a square shape when viewed in the extension direction of axis 20.

The inner edge of first end surface 31 is larger than the inner edge of second end surface 32 when viewed in the extension direction of axis 20. The inner edge of first end surface 31 is approximately the same in size as the outer edge of stator 21 of motor 2, meanwhile the inner edge of second end surface 32 is smaller than the outer edge of stator 21 of motor 2. Stator 21 can be inserted into tubular body 30 from first end surface 31, but cannot be inserted thereinto from second end surface 32.

### (2.3.3) Outer Wall Surface

As illustrated in FIG. 2, FIG. 3, and FIG. 6, four outer wall surfaces 4 are disposed to surround rotating shaft 23 and each outer wall surface 4 has a planar shape along rotating shaft 23. For convenience, among four outer wall surfaces 4, outer wall surface 4 whose normal is oriented rightward is referred to as first outer wall surface 41, outer wall surface 4 whose normal is oriented upward is referred to as second outer wall surface 42, outer wall surface 4 whose normal is oriented leftward is referred to as third outer wall surface 43, and outer wall surface 4 whose normal is oriented downward is referred to as fourth outer wall surface 44. First outer wall surface 41 to fourth outer wall surface 44 are each flat. However, first outer wall surface 41 to fourth outer wall surface 44 may be partially non-flat.

First outer wall surface 41 to fourth outer wall surface 44 are approximately rectangular when viewed from the front. In other words, first outer wall surface 41 is approximately rectangular when viewed from the right, second outer wall surface 42 is approximately rectangular when viewed from the top, third outer wall surface 43 is approximately rectangular when viewed from the left, and fourth outer wall surface 44 is approximately rectangular in shape when viewed from the bottom. Tubular body 30 is rectangular when viewed from any of the left, the right, the top, and the bottom.

In tubular body 30, opening 33 is formed in one outer wall surface 4, for example, outer wall surface 42, to pass through tubular body 30 in the internal-external direction perpendicular to the front-rear direction. Protrusion 111 can be inserted into opening 33. Through opening 33, protrusion 111 of substrate 11 is drawn to the outside of motor frame 3 and connected to an external signal line or an external power line. By opening 33, positioning of substrate 11 with respect to motor frame 3 is performed.

### (2.3.4) Inner Wall Surface

Inner wall surface 5 has a cylindrical inner surface shape to surround rotating shaft 23 and extends along rotating shaft 23. Stator 21 of motor 2 is fitted into inner wall surface 5. In a first embodiment, step portion 51 (see FIG. 1) is formed on a part of inner wall surface 5 in the extension direction of the axis (that is, in the front-rear direction) and slightly smaller in diameter than portions present forward and rearward of step portion 51. Step portion 51 is a contact portion configured to come into contact with motor 2 to be fitted inside.

A plurality of protrusions 52 is formed on inner wall surface 5. Protrusion 52 is formed on a portion corresponding to recess 615 of stator segment 6 of stator 21 to be fitted inside. In the present embodiment, protrusion 52 is a ridge having an arc-shaped cross-section and extending parallel to the extension direction of axis 20. The cross-section shape of protrusion 52 is the same as that of recess 615, so that protrusion 52 is fitted into recess 615.

### (2.3.5) Groove

Joint portion 15 is positioned between two adjacent outer wall surfaces 4 of four outer wall surfaces 4. In each of four joint portions 15, groove 16 extending parallel to axis 20 and recessed in an arc form toward axis 20 is formed. Furthermore, the arrangement of groove 16 will be described in the following. In each joint portion 15, there are two geometric planes respectively including two outer wall surfaces 4 adjacent to joint portion 15. Groove 16 is formed to be recessed toward axis 20 when viewed from each of these two geometric planes. Groove 16 is a groove extending in the extension direction of axis 20.

Each of four joint portions 15 includes groove 16 extending in the front-rear direction over the entire length of an area in which inner wall surface 5 and motor 2 come into contact with each other. In the present embodiment, stator 21 to be fitted comes into contact with inner wall surface 5 over the entire length, in the front-rear direction, of an area in which step portion 51 of inner wall surface 5 is formed.

### (2.3.6) Wall

As illustrated in FIG. 3, at least one joint portion 15 includes wall 34. Wall 34 is a portion of joint portion 15, in which groove 16 is not formed, and closes one end of groove 16 in the extension direction of axis 20. In the present embodiment, wall 34 is formed on all four joint portions 15.

Wall 34 is formed at the rear end of joint portion 15. Therefore, groove 16 formed on joint portion 15 is not open rearward, but is open frontward.

Wall 34 constitutes an attachment unit for attaching motor frame 3 to an external member. Here, the external member is a member into which motor device 1 is incorporated, such as, but not limited to, a machine tool. In wall 34, through-hole 35 passing through wall 34 in the front-back direction is formed, and a fastening tool including a bolt and a nut is screwed into through-hole 35 to attach tubular body 30 to the external member. When tubular body 30 is attached to the external member, the fastening tool is rotated by a tool such as a wrench or a screwdriver, and, at this time, a worker can insert the tool into groove 16 and thereby more easily conduct fastening work using the fastening tool.

The provision of the attachment unit including wall 34 causes a specific member to be more easily attached to tubular body 30. In particular, wall 34 is formed at a position to overlap groove 16 in the front-rear direction, which makes it easier to attach a specific member to tubular body 30 without increasing the size of tubular body 30.

In first end surface 31, fastening hole 311 into which a bolt is screwed is formed. Bracket 12 is attached by screwing a bolt into fastening hole 311.

### (3) Thickness of Tubular Body

The wall thickness of tubular body 30 will be described in the following. First, the thickness of tubular body 30 in the internal-external direction perpendicular to the front-rear direction is defined as wall thickness t (mm). An angle with respect to reference line 10 around axis 20 at any point of tubular body 30 is defined as angle θ (°). Note that reference line 10 starts at axis 20 and extends in a direction perpendicular to axis 20 and perpendicular to a direction from axis 20 toward protrusion 111 (see FIG. 2). The unit of the wall thickness t and the unit of the angle θ are for convenience, and the unit of the wall thickness t does not have to be (mm) and the unit of the angle θ does not have to be (°). Referring to FIG. 2 and FIG. 3, θ increases counterclockwise around axis 20.

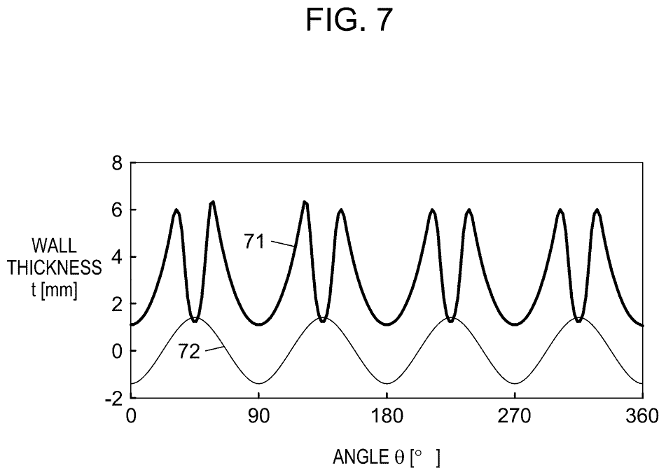

Next, let t=f(θ) be a thickness function. FIG. 7 is a diagram illustrating a relationship between the wall thickness t of the motor frame and the angle θ according to the embodiment of the present disclosure. The relationship between t and θ in the present embodiment is indicated by curve 71 in FIG. 7. Note that, in FIG. 7, the wall thickness t is a thickness in the extension direction of axis 20 at the center of a portion configured to come into contact with stator 21 to be fitted inside, and the angle θ is represented by (°).

Tubular body 30 is approximately square when viewed in the extension direction of axis 20 and includes grooves 16 formed on four joint portions 15, which results in the t−θ relationship indicated by curve 71 in FIG. 7.

Fourier series expansion of the thickness function is performed. The waveform of a quartic component resulting from the Fourier series expansion is indicated by curve 72 in FIG. 7. As described above, tubular body 30 is approximately square when viewed in the extension direction of axis 20, and therefore the waveform of the quartic component resulting from the Fourier series expansion is considered to best represent the trend of the relationship between the wall thickness t and the angle θ over the entirety of tubular body 30. In other words, when stator 21 is fitted into tubular body 30, portions that greatly affect the deformation of tubular body 30 and stator 21 can be determined from the waveform of the quartic component resulting from the Fourier series expansion. When the deformation of the entirety of tubular body 30 is considered using line 72 in FIG. 7, portions of tubular body 30 in which the wall thickness t of tubular body 30 is the smallest and accordingly tubular body 30 is most easily deformed are portions at angles θ of 90°, 180°, 270°, and 360°. From the relationship between the wall thickness t and the angle θ indicated by line 71 in FIG. 7, it is understood that, at eight portions at angles θ of 45°, 90°, 135°, 180°, 225°, 270°, 315°, and 360°, the wall thickness t reaches the minimum value, meanwhile tubular body 30 is most greatly deformed in portions at angles θ of 90°, 180°, 270°, and 360°at which the quartic component resulting from the Fourier series expansion reaches the minimum value.

In the present embodiment, center portions (recesses 615) of stator segments 6 in the circumferential direction of rotating shaft 23 are positioned at portions (portions at angles θ of 90°, 180°, 270°, and 360°) of inner wall surface 5 at which the minimum value of the waveform of the quartic component resulting from the Fourier series expansion of the thickness function is obtained. Stator 21 to be fitted into tubular body 30 includes stator segments 6 and is fitted into tubular body 30 by shrink-fitting without being welded thereto. In addition, two adjacent stator segments 6 are not welded to each other and not fixed to each other, and therefore it is considered that stator 21 is most greatly deformed at a boundary portion between two adjacent stator segments 6.

Therefore, in the case where a portion at an angle θ of 90°, 180°, 270°, or 360° at which tubular body 30 is most greatly deformed is in agreement with a boundary portion between two adjacent stator segments 6 at which stator 21 is most greatly deformed, the possibility of great deformation of tubular body 30 and stator 21 due to fitting of stator 21 into tubular body 30 is raised. Therefore, in the present embodiment, each of the portions at angles θ of 90°, 180°, 270°, and 360° at which tubular body 30 is most greatly deformed is designed so as not to be in agreement with a boundary portion between stator segments 6 at which stator 21 is most greatly deformed, but to be in agreement with a circumferential center portion (recess 615) of stator segment 6.

Thus, each of the portions at angles θ of 90°, 180°, 270°, and 360° at which tubular body 30 is most greatly deformed is not in agreement with a boundary portion between two adjacent stator segments 6 at which stator 21 is most greatly deformed, hence tubular body 30 and stator 21 are substantially prevented from being greatly deformed. As a result, tubular body 30 and stator 21 can be substantially prevented from being deformed, and the external shape of inner wall surface 5 of tubular body 30 and the external shape of stator 21 when viewed from the extension direction of axis 20 can be made closer to a perfect circle, and consequently cogging torque generated in motor 2 can be reduced.

In the present embodiment, stator 21 includes twelve stator segments 6, and therefore, when the circumferential center portion of stator segment 6 is positioned at a portion at angle θ of 90°, 180°, 270°, or 360°, a boundary portion between stator segments 6 at which stator 21 is most greatly deformed is positioned at four portions at angles θ of 45°, 135°, 225°, and 315°. However, groove 16 extending parallel to axis 20 and recessed in an arch shape toward axis 20 is formed on each of four joint portions 15 at angles θ of 45°, 135°, 225°, and 315°, whereby the rigidity of joint portions 15 of tubular body 30 is enhanced. As a result, tubular body 30 and stator 21 can be further substantially prevented from being deformed, and consequently cogging torque generated in motor 2 can be reduced.

Since protrusion 52 is formed on inner wall surface 5 of tubular body 30 and recess 615 into which protrusion 52 fits is formed on stator segment 6, the positioning of stator segment 6 with respect to tubular body 30 can be easily and surely performed.

### (4) Modification

The shape of substrate 11 is not limited. In addition, substrate 11 does not have to be fixed to stator 21 and does not necessarily have to be provided in motor device 1. Protrusion 111 does not have to protrude from the main body of substrate 11 in a direction opposite to axis 20 and the protrusion direction of protrusion 111 is not limited. In addition, protrusion 111 does not have to be formed on substrate 11. The number of holes 112 formed in substrate 11 is not limited. In addition, holes 112 do not have to be formed in substrate 11.

Position detector 121, bracket 12, and seal 122 are optional constituents and motor device 1 does not have to include these constituents.

Position detector 121 may be a slip ring, for example, and is not limited to a rotary encoder.

Motor 2 is not limited to a servomotor.

Rotor 22 is not limited to a surface-magnet rotor.

Opening 33 is an optional constituent and does not have to be formed in tubular body 30.

In inner wall surface 5, a portion not constituting the cylindrical inner surface may be present. In inner wall surface 5, the contact portion configured to come into contact with stator 21 of motor 2 to be fitted inside may extend over the entire length of inner wall surface 5 in the extension of the axis (that is, the front-rear direction). In addition, the contact portion of inner wall surface 5, the contact portion being configured to come into contact with stator 21 of motor 2 to be fitted inside, does not have to be composed of step portion 51. That is, portions positioned frontward and rearward of the contact portion and the contact portion may be on the same plane extending in the front-rear direction.

Groove 16 does not have to be formed over the entire length in the front-rear direction of an area in which the contact portion is positioned.

The number of stator segments 6 is not limited to twelve. Stator segments 6 do not necessarily have to be separated evenly in the circumferential direction of rotating shaft 23.

The shape of recess 615 is not limited to a circular arc in cross-section. Recess 615 does not have to be provided in core 61.

The number of members constituting insulator 63 is not limited. Insulating paper may be used in place of the insulator, or the insulator may be used in place of insulating paper.

The shape of protrusion 52 is not limited to a circular arc in cross-section. Protrusion 52 does not have to be provided in inner wall surface 5.

Groove 16 does not have to be formed on all four joint portions 15 and the number of grooves 16 is not limited. Groove 16 does not necessarily have to be formed on motor frame 3.

Wall 34 does not have to be formed on all four joint portions 15 and the number of walls 34 is not limited. Wall 34 may be formed at the front end of joint portion 15.

Wall 34 does not necessarily have to be formed on motor frame 3.

### (5) Conclusion

As described above, motor frame (3) of a first aspect includes tubular body (30). Tubular body (30) allows motor (2) to penetrate in the extension direction of axis (20) of rotating shaft (23) of motor (2) including stator (21) to be fitted thereinto. Stator (21) of motor (2) is divided into a plurality of stator segments (6) in the circumferential direction of rotating shaft (23), each stator segment (6) including tooth (612) extending toward axis (20). Tubular body (30) includes four outer wall surfaces (4) and inner wall surface (5). Four outer wall surfaces (4) are disposed to surround rotating shaft (23) and each outer wall surface (4) has a planar shape along rotating shaft (23). Inner wall surface (5) surrounds rotating shaft (23) and has a cylindrical inner surface shape along rotating shaft (23). The thickness of tubular body (30) in the internal-external direction perpendicular to the extension direction of axis (20) is defined as wall thickness t (mm). An angle with respect to a reference line around axis (20) at any point of tubular body (30) is defined as angle θ (°). The thickness function is defined as t=f(θ). A portion of inner wall surface (5) at an angle at which the minimum value of the waveform of a quartic component resulting from the Fourier series expansion of the thickness function is obtained is a center portion (recess (615)), in the circumferential direction of rotating shaft (23), of stator segments (6).

In the first aspect, a portion at an angle at which tubular body (30) is most greatly deformed is not in agreement with a boundary portion between two adjacent stator segments (6) at which stator (21) is most greatly deformed, hence tubular body (30) and stator (21) are substantially prevented from being greatly deformed. As a result, cogging torque generated in motor (2) can be reduced.

A second aspect can be realized in combination with the first aspect. In the second aspect, tubular body (30) further includes four joint portions (15) each positioned between adjacent outer wall surfaces (4) of four outer wall surfaces (4). Groove (16) extending parallel to axis (20) and recessed in an arch shape toward axis (20) is formed on each of four joint portions (15).

In the second aspect, the rigidity of tubular body (30) is enhanced because of the presence of groove (16), hence cogging torque generated in motor (2) can be further reduced.

A third aspect can be realized in combination with the first or second aspect. In the third aspect, motor (2) includes insulator (63) and a printed circuit board. Insulator (63) is attached to stator (21). With positioned by pin (64) formed on insulator (63), the printed circuit board is attached to insulator (63), and the printed circuit board includes protrusion (111) protruding in a direction opposite to rotating shaft (23). In motor frame (3), a recess or opening (33) that allows protrusion (111) to be inserted thereinto is formed.

In the third aspect, the positioning of stator segments (6) with respect to tubular body (30) can be easily and surely performed.

A fourth aspect can be realized in combination with any one of the first to three aspects. In the fourth aspect, a plurality of protrusions (52) is formed on inner wall surface (5) of tubular body (30). Recess (615) is formed on each of stator segments (6) to allow each of protrusions (52) to be fitted into recess (615).

In the fourth aspect, the positioning of stator segments (6) with respect to tubular body (30) can be easily and surely performed.

A fifth aspect can be realized in combination with any one of the first to fourth aspects. In the fifth aspect, motor device (1) includes motor frame (3) according to any one of the first to fourth aspects and motor (2).

In the fifth aspect, a portion at which tubular body (30) is most greatly deformed is not in agreement with a boundary portion between two adjacent stator segments (6) at which stator (21) is most greatly deformed, hence tubular body (30) and stator (21) are substantially prevented from being greatly deformed. As a result, cogging torque generated in motor (2) can be reduced.

### INDUSTRIAL APPLICABILITY

The motor frame and the motor device according to the present disclosure can easily make uniform the distribution of stress applied to the stator to be fitted thereinto. As a result, cogging torque generated in the motor can be reduced. In other words, the motor frame and the motor device according to the present disclosure are industrially useful.

### REFERENCE MARKS IN THE DRAWINGS

1 . . . motor device
10 . . . reference line
111 . . . protrusion
15 . . . joint portion
16 . . . groove
2 . . . motor
20 . . . axis
21 . . . stator
23 . . . rotating shaft
3 . . . motor frame
30 . . . tubular body
33 . . . opening
4, 41, 42, 43, 44 . . . outer wall surface
5 . . . inner wall surface
6 . . . stator segment
612 . . . tooth
615 . . . recess
63, 631, 632 . . . insulator
64 . . . pin

1. A motor frame, comprising:
a tubular body including a hole penetrating the tubular body in an extension direction of an axis of a rotating shaft of a motor, the motor including a stator configured to be fitted into the tubular body, wherein:
the stator of the motor includes a plurality of stator segments obtained by dividing the stator in a circumferential direction of the rotating shaft, each of the stator segments including a tooth extending toward the rotating shaft,
the tubular body includes:
four outer wall surfaces disposed to surround the rotating shaft and each having a planar shape along the rotating shaft; and
an inner wall surface surrounding the rotating shaft and having a cylindrical inner surface shape along the rotating shaft,
a thickness of the tubular body in an internal-external direction perpendicular to the extension direction of the axis is defined as a wall thickness t (mm),
an angle with respect to a reference line around the axis at any point of the tubular body when the tubular body is viewed in the extension direction of the axis is defined as an angle θ (rad), and,
when a thickness function is defined as t=f(θ),
a portion of the inner wall surface, the portion being positioned at the angle at which a minimum value of a waveform of a quartic component resulting from Fourier series expansion of the thickness function is obtained, is a center contact portion configured to come into contact with center portions of the stator segments in the circumferential direction of the rotating shaft.

2. The motor frame according to claim 1, wherein
the tubular body further includes four joint portions each positioned between adjacent outer wall surfaces of the four outer wall surfaces, and,
in each of the four joint portions, a groove extending parallel to the axis and recessed in an arch shape toward the axis is formed.

3. The motor frame according to claim 1, wherein
the motor includes:
an insulator configured to be attached to the stator; and
a printed circuit board configured to be attached to the insulator, with the printed circuit board positioned by a pin formed on the insulator, and including a protrusion protruding toward a direction opposite to the rotating shaft, and,
in the motor frame, a recess or an opening into which the protrusion is insertable is formed.

4. The motor frame according to claim 1, wherein
a plurality of protrusions is formed on the inner wall surface of the tubular body, and,
in the stator segments, recesses are formed, each of the recesses allowing a corresponding one of the protrusions to be fitted into the recess.

5. A motor device, comprising:
the motor frame according to claim 1; and
the motor.
